(19) United States
(12) Patent Application Publication
(10) Pub. No.: US 2025/0307889 A1
(43) Pub. Date: Oct. 2, 2025

(54) INFORMATION PROCESSING APPARATUS, PRESENTING METHOD, AND NON-TRANSITORY COMPUTER-READABLE MEDIUM

(71) Applicant: NEC Corporation, Tokyo (JP)

(72) Inventors: Yasuhiko YOSHIDA, Tokyo (JP); Rui KONDO, Tokyo (JP)

(73) Assignee: NEC Corporation, Tokyo (JP)

(21) Appl. No.: 19/064,885

(22) Filed: Feb. 27, 2025

(30) Foreign Application Priority Data
Mar. 28, 2024 (JP) 2024-053502

(51) Int. Cl. G06Q 30/0601

(52) U.S. Cl. CPC G06Q 30/0609; G06Q 30/0641

(57) ABSTRACT

An information processing apparatus, a presenting method, and a program that promote a user purchasing item data from a rightful seller in a metaverse are provided. An information processing apparatus includes: an analysis unit that analyzes a credibility of a seller of an item tokenized by non-fungible tokens (NFTs) used by a first user in a metaverse space on the basis of a trade history of the NFTs sold by the seller; and a presenting unit that presents the credibility of the seller and a link to the seller to a second user.

### INCORPORATION BY REFERENCE

This application is based upon and claims the benefit of priority from Japanese patent application No. 2024-053502, filed on Mar. 28, 2024, the disclosure of which is incorporated herein in its entirety by reference.

### TECHNICAL FIELD

The present disclosure relates to an information processing apparatus, a presenting method, and a program.

### BACKGROUND ART

Japanese Unexamined Patent Application Publication No. 2023-152704 discloses a technique of exhibiting digital content associated with non-fungible tokens (NFTs) on a virtual reality space.

### SUMMARY

Since data of an item (for example, an avatar) used in a metaverse space is easily copied, there is a concern that a user may purchase the item from someone who is not a rightful seller (for example, a creator).

The present disclosure was made to solve such a problem, and an example object thereof is to provide an information processing apparatus, a presenting method, and a program that promote a user purchasing item data from a rightful seller in a metaverse.

In a first example aspect, an information processing apparatus according to the present disclosure includes:
an analysis unit that analyzes a credibility of a seller of an item tokenized by non-fungible tokens (NFTs) used by a first user in a metaverse space on the basis of a trade history of the NFTs sold by the seller; and
a presenting unit that presents the credibility of the seller and a link to the seller to a second user.

In a second example aspect, a presenting method according to the present disclosure includes:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.

In a third example aspect, a program according to the present disclosure causes a computer to execute processing of:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.

According to the present disclosure, it is possible to provide an information processing apparatus, a presenting method, and a program that promote a user purchasing item data from a rightful seller in a metaverse.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of configuration of an information processing apparatus according to the present disclosure;

FIG. 2 is a block diagram illustrating an example of a flow of a presenting method according to the present disclosure;

FIG. 3 is a block diagram illustrating an example of the configuration of the information processing apparatus according to the present disclosure; FIG. 4 is a block diagram illustrating an example of operations of the information processing apparatus according to the present disclosure; and

FIG. 5 is a block diagram illustrating an example of a hardware configuration of the information processing apparatus and the like according to the present disclosure.

### EXAMPLE EMBODIMENT

### First Example Embodiment

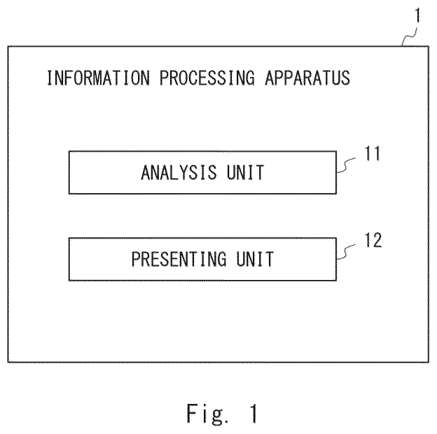

Hereinafter, a first example embodiment will be described with reference to the drawings. FIG. 1 is a block diagram illustrating a configuration of an information processing apparatus 1 according to the present disclosure. The information processing apparatus 1 may be a computer apparatus that operates when a processor executes a program stored in a memory. The information processing apparatus 1 may be, for example, a server apparatus. Furthermore, the information processing apparatus 1 may be constituted by a plurality of computer devices. In this case, components or functions constituting the information processing apparatus 1 may be distributed and arranged in a plurality of computer apparatuses. The plurality of computers may be connected via a network or may be directly connected via a cable or the like.

An information processing apparatus 1 includes an analysis unit 11 and a presenting unit 12. The analysis unit 11 and the presenting unit 12 may be software or modules, processing of which is executed by a processor executing a program stored in a memory. Alternatively, the analysis unit 11 and the presenting unit 12 may be hardware such as circuitries or chips.

The analysis unit 11 analyzes a credibility of a seller of an item tokenized by non-fungible tokens (NFTs) used by a first user in a metaverse space on the basis of a trade history of the NFTs sold by the seller.

The presenting unit 12 presents the credibility of the seller and a link to the seller to a second user.

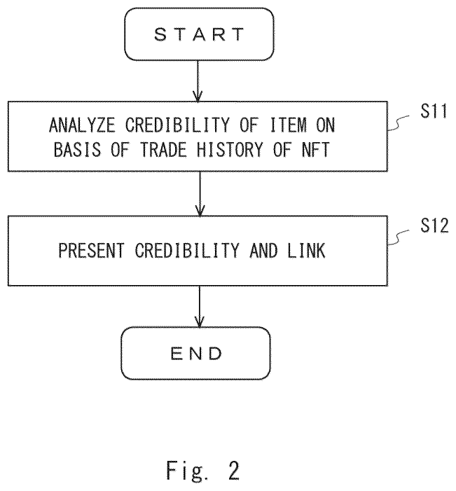

FIG. 2 is a flowchart illustrating a flow of a presenting method according to the present disclosure. First, the analysis unit 11 of the information processing apparatus 1 analyzes the credibility of the seller of the item tokenized by the NFTs used by the first user in the metaverse space on the basis of the trade history of the NFTs sold by the seller (Step S11). Next, the presenting unit 12 of the information processing apparatus 1 presents the credibility of the seller and the link to the seller to the second user (Step S12).

According to the information processing apparatus and the presenting method of the first example embodiment, it is possible to promote a user purchasing item data from a rightful seller in a metaverse.

### Second Example Embodiment

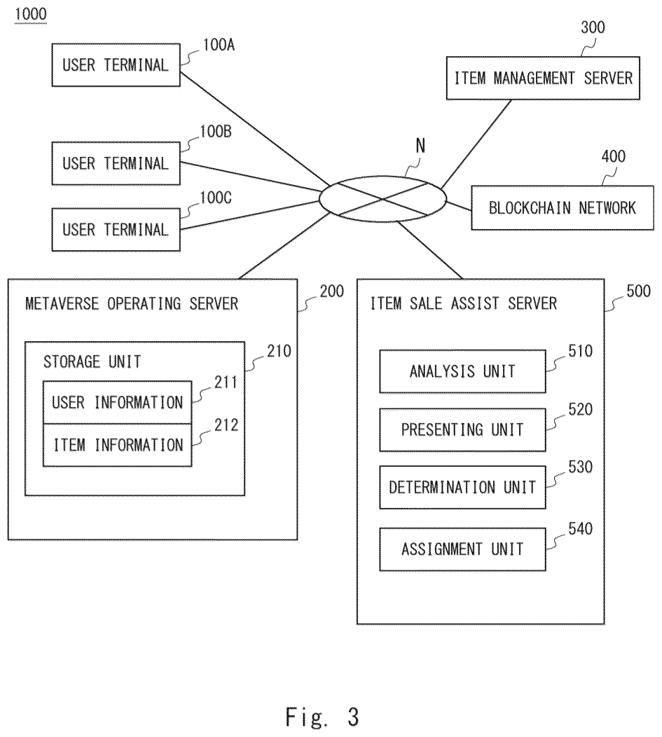

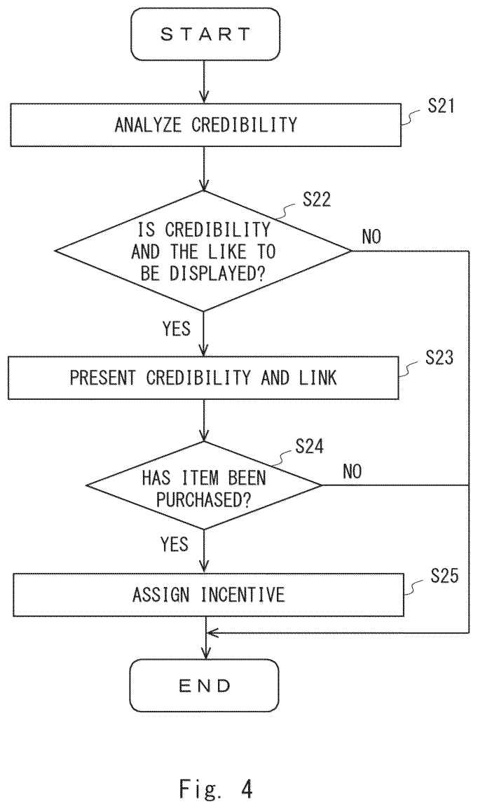

FIG. 3 is a block diagram illustrating an example of a configuration of an information processing apparatus 1000 according to the present disclosure. The information processing apparatus 1000 is a specific example of the information processing apparatus 1 described above. Alternatively, it is also possible to interpret that an item sale assist server 500, which will be described later, is a specific example of the information processing apparatus 1.

The information processing apparatus 1000 includes user terminals 100A to 100C, a metaverse operating server 200, an item management server 300, a blockchain network 400, and an item sale assist server 500. The user terminals 100A to 100C, the metaverse operating server 200, the item management server 300, the blockchain network 400, and the item sale assist server 500 are communicatively connected to each other via a network N. The network N may be, for example, a communication line network such as the Internet, an intranet, a mobile phone network, or a local area network (LAN). The network N may be a wired or wireless network.

The user terminals 100A to 100C are used by users UA to UC, respectively. In a case where the user terminals 100A to 100C are not distinguished from each other, the user terminals 100A to 100C may be simply referred to as user terminals 100. In a case where the users UA to UC are not distinguished from each other, the users UA to UC may be simply referred to as users U. The user terminals 100 are, for example, head mounted displays (HMDs), personal computers (PCs), smartphones, or tablet terminals.

Each user terminal 100 includes an interface that allows a user U to input information thereto (referred to as an input interface). The input interface is, for example, a controller in a head mounted display, a touch panel in a smartphone, or a keyboard or a mouse in a personal computer. The above controller may incorporate an operation button and various sensors that detect a direction and a motion (acceleration, rotation, and the like) of the controller. The user U can cause an avatar to move, change a viewpoint, or make utterances in a metaverse by inputting information to the user terminal 100 via the input interface. In addition, the user U can select link information displayed in the metaverse or in a window by inputting information to the user terminal 100.

Each user terminal 100 includes an interface that displays various kinds of information for the user U through the user terminal 100 (referred to as a display interface). The display interface may be configured of, for example, a liquid crystal display. In a case where the user terminal 100 is a head mounted display, the display interface is attached to the head of the user U and covers the field of view of both eyes of the user. The user U wearing the head mounted display can view a video displayed on the display interface. Various kinds of information such as objects in the metaverse and web pages are displayed on the display interface.

The user terminal 100 may further include a camera that images the eyes of the user U. A video captured by the camera may be used for analysis of a line-of-sight direction of the user U, analysis of pupil information of the user U, and the like. For example, it is known that the pupils of the user U are enlarged if the user U is curious about or is interested in a target.

The user terminal 100 is a computer apparatus including a processor, a memory, and the like. The user terminal 100 performs various kinds of processing by the processor in the user terminal 100 executing a predetermined program.

The metaverse operating server 200 is a server that realizes the virtual space of the metaverse. The metaverse operating server 200 may be a server operating a metaverse game. The metaverse operating server 200 is a computer apparatus including a processor, a memory, and the like. The metaverse operating server 200 performs various kinds of processing by the processor in the metaverse operating server 200 executing a program.

The metaverse operating server 200 includes a storage unit 210. The storage unit 210 is a storage device that the processor of the metaverse operating server 200 can access. The storage unit 210 includes user information 211 and item information 212. The user information 211 is account information of the users UA, UB, and UC who use the virtual space of the metaverse. The user information 211 may further store information of points that each user U can use in the virtual space. The user information 211 may further include information regarding the position of the avatar of the user U, a login time, and the like. The item information 212 is information regarding an item used by each user U. The item may be an avatar or an item used by the avatar (for example, a vehicle or clothes). The item information 212 includes information regarding an item tokenized by the NFTs. The item information 212 may be information indicating which item each user U possesses. Alternatively, the item information 212 may include information regarding a 3D model.

The metaverse operating server 200 causes the avatar of each user U to move in the metaverse space in accordance with information input to the user terminal 100. Then, the metaverse operating server 200 or the user terminal 100 generates a screen to be displayed on the user terminal 100 in accordance with the position or the like of the avatar and causes the display interface of the user terminal 100 to display the generated screen. The metaverse operating server 200 may transmit information regarding the position of the avatar or information regarding the generated screen to the user terminal 100.

The item management server 300 stores data of the item tokenized by the NFTs at a predetermined uniform resource locator (URL). The URL may be included in the NFTs as metadata of the data of the item. The item management server 300 or the user terminal 100 may request the blockchain network 400 to record the fact that an agreement on selling and buying of the item has been made.

The blockchain network 400 is constituted by a plurality of nodes and records a trade history of the item on the blockchain. Here, the blockchain represents a plurality of connected blocks representing a trade history of the item. The blockchain network 400 may be a public chain or a private chain. The blockchain network 400 generates a block indicating that the item has been transferred to the user U in response to a request from the item management server 300 or the user terminal 100 and connects the newly generated block to the blockchain that has already been generated. The item may be transferred among the users U.

The item sale assist server 500 may be a computer apparatus operating by a processor executing a program stored in a memory. The item sale assist server 500 includes an analysis unit 510, a presenting unit 520, a determination unit 530, and an assignment unit 540. Each component constituting the item sale assist server 500 may be software or a module, processing of which is executed by the processor executing the program stored in the memory. Alternatively, each component constituting the item sale assist server 500 may be hardware such as a circuitry or a chip.

The analysis unit 510 is a specific example of the aforementioned analysis unit 11. The analysis unit 510 analyzes the credibility of the seller of the item tokenized by the NFTs and used by the first user (for example, user UA). Hereinafter, a case where the credibility of the seller of the item IA used by the user UA is analyzed will be mainly described. Note that the analysis unit 510 may analyze the credibility of the item IA in advance or may start the analysis of the credibility when the user UB or the user UC visually recognizes the item IA.

The analysis unit 510 refers to the blockchain held by the blockchain network 400 and specifies the seller (for example, a creator) of the item IA tokenized by the NFTs used by the user UA. Then, the analysis unit 510 extracts a trade history of the NFTs sold by the seller of the NFTs from the blockchain and analyzes the credibility of the seller on the basis of the trade histories.

The analysis unit 510 calculates the credibility such that a rightful seller of the NFTs has a high credibility. The analysis unit 510 may analyze the credibility using artificial intelligence (AI) that has learned the trade history of the NFTs. For example, the AI may be trained to receive an input of data representing the trade history and output the credibility of the seller corresponding to the trade history.

The analysis unit 510 may calculate the credibility such that the credibility is higher as the number of users U who have purchased the NFTs from the seller is larger, for example. In a case where many users U have purchased the NFTs from a certain seller, the credibility of the seller is considered to be high. Also, the analysis unit 510 may calculate the credibility such that the credibility is higher as an activity level of the user who has purchased the NFTs from the seller is higher. The activity level represents how many trades of the NFTs or the FTs associated with a wallet (address) of the user the user has had, for example. In a case where the user U who usually trades the NFTs has purchased the NFTs from a certain seller, the credibility of the seller is considered to be high. There is a probability that using the activity level may prevent a seller from fraudulently raising the credibility.

The presenting unit 520 is a specific example of the aforementioned presenting unit 12. The presenting unit 520 presents the credibility of the seller and a link to the seller to other users (for example, the user UB and the user UC). Hereinafter, a case where the credibility and the like are presented to the user UB will be mainly described. The link is, for example, a link to a website where the seller sells the item. The user UB can purchase the item tokenized by the NFTs from the site by performing an operation of selecting the link. The link may be incorporated in the item.

The determination unit 530 determines whether or not to present the credibility and the link (also referred to as the credibility and the like) on the basis of a behavior of the user UB. The determination unit 530 may provide through an NFT mark or the like an indication that the item IA has been tokenized by the NFTs in a case where the user UB has visually recognized the item IA, and may determine to present the credibility and the like in a case where the second user has performed a selecting operation (for example, an operation of selecting the NFT mark), for example.

The determination unit 530 can determine whether or not the user UB has visually recognized the item IA (for example, an avatar) by analyzing a line of sight of the user UB. The determination unit 530 analyzes whether or not the item IA is included in a range of vision of the user UB or whether or not the line of sight of the user UB matches the item IA, for example, to determine whether or not the item IA has been visually recognized by the user UB. The determination unit 530 may determine whether or not the item IA has been visually recognized in consideration of a result of analyzing the pupils of the user UB. In a case where the line of sight of the user UB matches the item IA, and the pupils have been enlarged, the determination unit 530 determines that the item IA has been visually recognized.

The determination unit 530 may cause the NFT mark to be displayed in the surroundings of the item IA or cause the NFT mark to be displayed in an emphasized manner in a case where the user UB has visually recognized the item IA. Alternatively, the determination unit 530 may indicate that the item IA has been tokenized by the NFTs by changing a display form of the item IA. For example, the determination unit 530 may slightly enlarge the size of the item IA, apply a predetermined light color to the item IA, or display the contour of the item IA in an emphasized manner. The determination unit 530 determines to display the reliability and the like once the user UB selects the NFT mark or selects the item IA.

The assignment unit 540 assigns an incentive to the user UA in a case where the user UB has purchased the item. In this manner, each user U is promoted to use the item from the rightful seller. The assignment unit 540 may cause the user terminal 100A to display the incentive. The incentive may be money or may be points that can be used in the metaverse.

FIG. 4 is a flowchart illustrating an example of operations of the information processing apparatus 1000. First, the analysis unit 510 of the item sale assist server 500 analyzes a credibility of the item IA (Step S21). Next, the determination unit 530 of the item sale assist server 500 determines whether or not to display the credibility and the like on the basis of motion of the user UB (Step S22). In a case where it is determined that the credibility and the like are not to be displayed (NO in Step S22), the item sale assist server 500 ends the processing. In a case where it is determined that the credibility and the like are to be displayed (YES in Step S22), the presenting unit 520 of the item sale assist server 500 presents the credibility and the link to the user UB (Step S23). Next, the item sale assist server 500 determines whether or not the user UB has purchased the item IA (Step S24). In a case where the user UB has purchased the item IA, the item management server 300 may provide a notification to the item sale assist server 500. Alternatively, the item sale assist server 500 may refer to a trade history recorded in the blockchain. In a case where the user UB has not purchased the item IA (NO in Step S24), the item sale assist server 500 ends the processing. In a case where the user UB has purchased the item IA (YES in Step S24), the assignment unit 540 of the item sale assist server 500 assigns the incentive to the user UA (Step S25).

In a case where the information processing apparatus 1000 is used, it is possible to present the credibility to the user UB and to promote the user UB purchasing the item from the rightful seller. In addition, the user UA uses the item purchased from the rightful seller to obtain the incentive.

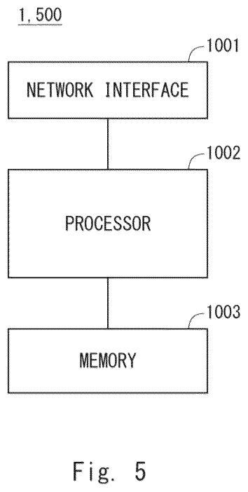

FIG. 5 is a block diagram illustrating an example of hardware configurations of the information processing apparatus 1 and the item sale assist server 500 (hereinafter, referred to as the information processing apparatus 1 and the like). Referring to FIG. 5, the information processing apparatus 1 and the like include a network interface 1001, a processor 1002, and a memory 1003. The network interface 1001 is used to communicate with other network node apparatuses that constitutes a communication system. The network interface 1001 may be used to perform wireless communication. For example, the network interface 1001 may be used to perform wireless LAN communication specified in IEEE 802.11 series or mobile communication specified in the 3rd Generation Partnership Project (3GPP; registered trademark). Alternatively, the network interface 1001 may include, for example, a network interface card (NIC) complying with IEEE 802.3 series.

The processor 1002 reads and executes software (computer program) from the memory 1003 to perform the processing in Steps S11 and S12 in FIG. 2 and Steps S21 to S25 in FIG. 4. The processor 1002 may be, for example, a microprocessor, an MPU, or a CPU. The processor 1002 may include a plurality of processors.

The memory 1003 is constituted by a combination of a volatile memory and a nonvolatile memory. The memory 1003 may include a storage disposed away from the processor 1002. In this case, the processor 1002 may access the memory 1003 via an input/output (I/O) interface, which is not illustrated. In the example in FIG. 5, the memory 1003 is used to store a group of software modules. The processor 1002 can perform the processing in Steps S11, S12, and S21 to S25 by reading and executing the group of software modules from the memory 1003.

As described using FIG. 5, each of the processors included in the information processing apparatus 1 and the like in the aforementioned example embodiment executes one or more programs including a group of commands for causing a computer to perform the algorithms described using the drawings.

In the aforementioned example, the program includes a group of commands (or software codes) for causing a computer to execute one or more functions described in the example embodiment in a case where the program is read by the computer. The program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage apparatus. The program may be transmitted through a transitory computer readable medium or a communication medium. By way of example, and not limitation, transitory computer readable or communication media include electrical, optical, acoustic, or other forms of propagated signals.

Note that the technical ideas of the present disclosure are not limited to the above example embodiment and can be appropriately modified without departing from the gist.

Although the present disclosure has been described hitherto with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each drawing is merely illustrative for describing one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing illustrative example embodiments are not necessarily mandatory, and some features or steps may be omitted. The order of the steps described in any drawing may be changed as appropriate.

Although some or all of the above-described example embodiments may be described as in the following Supplements, the present disclosure is not limited to the following Supplements.

Some or all of the elements (such as configurations and functions, for example) described in Supplementary Notes 2 to 8 depending from Supplementary Note 1 may depend from Supplementary Notes 9 to 10 as well with depending relationships similar to those of Supplementary Notes 2 to 8. Some or all of the elements described in any supplementary notes may be applied to various kinds of hardware, software, recording means for recording software, systems, and methods.

### Supplementary Note 1

An information processing apparatus including:
an analysis unit that analyzes a credibility of a seller of an item tokenized by non-fungible tokens (NFTs) used by a first user in a metaverse space on the basis of a trade history of the NFTs sold by the seller; and
a presenting unit that presents the credibility of the seller and a link to the seller to a second user.

### Supplementary Note 2

The information processing apparatus according to Supplementary Note 1, further including an assigning unit that assigns an incentive to the first user in a case where the second user purchases the item.

### Supplementary Note 3

The information processing apparatus according to Supplementary Note 1, or 2, in which the analysis unit calculates the credibility of the seller such that the credibility becomes higher as the number of users who have purchased the NFTs from the seller becomes larger.

### Supplementary Note 4

The information processing apparatus according to Supplementary Note 1, or 2, in which the analysis unit calculates the credibility of the seller such that the credibility becomes higher as activity levels of users who have purchased the NFTs from the seller become higher.

### Supplementary Note 5

The information processing apparatus according to Supplementary Note 1, or 2, in which the analysis unit analyzes the credibility using an artificial intelligence (AI) that has learned a trade history of the NFTs.

### Supplementary Note 6

The information processing apparatus according to Supplementary Note 1, or 2, further including a determination unit that determines whether or not to present the credibility and the link on the basis of motion of the second user. (Supplementary Note 7

The information processing apparatus according to Supplementary Note 6, in which the determination unit provides an indication that the item has been tokenized by the NFTs to the second user in a case where the second user has visually recognized the item, and determines to present the credibility and the link in a case where the second user has performed a selecting operation.

### Supplementary Note 8

The information processing apparatus according to Supplementary Note 1, or 2, in which the item is an avatar used inside a game.

### Supplementary Note 9

A presenting method including:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.

### Supplementary Note 10

A program that causes a computer to execute processing of:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.

What is claimed is:

1. An information processing apparatus comprising:
at least one memory storing instructions and at least one processor configured to execute the instructions to;
analyze a credibility of a seller of an item tokenized by non-fungible tokens (NFTs) used by a first user in a metaverse space on the basis of a trade history of the NFTs sold by the seller; and
present the credibility of the seller and a link to the seller to a second user.

2. The information processing apparatus according to claim 1, wherein the at least one processor is further configured to execute the instructions to:
assign an incentive to the first user in a case where the second user purchases the item.

3. The information processing apparatus according to claim 1, wherein the at least one processor is further configured to execute the instructions to:
calculate the credibility of the seller such that the credibility becomes higher as the number of users who have purchased the NFTs from the seller becomes larger.

4. The information processing apparatus according to claim 1, wherein the at least one processor is further configured to execute the instructions to:
calculate the credibility of the seller such that the credibility becomes higher as activity levels of users who have purchased the NFTs from the seller become higher.

5. The information processing apparatus according to claim 1, wherein the at least one processor is further configured to execute the instructions to:
analyze the credibility using an artificial intelligence (AI) that has learned a trade history of the NFTs.

6. The information processing apparatus according to claim 1, wherein the at least one processor is further configured to execute the instructions to:
determine whether or not to present the credibility and the link on the basis of motion of the second user.

7. The information processing apparatus according to claim 6, wherein the at least one processor is further configured to execute the instructions to:
provide an indication that the item has been tokenized by the NFTs to the second user in a case where the second user has visually recognized the item, and determine to present the credibility and the link in a case where the second user has performed a selecting operation.

8. The information processing apparatus according to claim 1, wherein the item is an avatar used inside a game.

9. A presenting method comprising:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.

10. A non-transitory computer-readable medium storing a program that causes a computer to execute processing of:
analyzing a credibility of a seller of an item tokenized by non-fungible tokens (NFTs) used by a first user in a metaverse space on the basis of a trade history of the NFTs sold by the seller; and
presenting the credibility of the seller and a link to the seller to a second user.
